(19) United States
(12) Patent Application Publication
(10) Pub. No.: US 2012/0188167 A1
(43) Pub. Date: Jul. 26, 2012

(54) CONTAINABLE COMPUTER KEYBOARD

(76) Inventor: Shao-Chieh TING, Banchiau City (TW)

(21) Appl. No.: 13/011,700

(22) Filed: Jan. 21, 2011

(51) Int. Cl. G06F 3/02

(52) U.S. Cl. 345/168

(57) ABSTRACT

In the present invention, a rear part at a bottom cover of a computer keyboard is provided with two elastic brackets which can be used to raise a height of the keyboard. The keyboard can be raised and can be put upside-down on a desktop by pulling out the elastic brackets. Left and right sides of the keyboard are provided respectively with a flat panel, allowing the keyboard to be put in a drawer of an office desk. Besides, the keyboard can be designed wirelessly or with wires.

### BACKGROUND OF THE INVENTION

a) Field of the Invention

The present invention relates to a containable computer keyboard, and more particularly to a computer keyboard which can be put upright on a desktop or contained in a drawer of an office desk, with the computer keyboard being able to be designed wirelessly or with wires, wherein when being designed as a wired keyboard, a connection wire thereof can be unloaded by itself for containment.

b) Description of the Prior Art

As progress of computer technologies, a computer input device has been evolved from keyboard input, mouse input and stylus input to finger input, in addition to voice input. In this era that computer touch-control is prevailing, although being not used frequently, the keyboard input is still indispensable. Therefore, an issue of containing keyboards that are not used often arises, such as how to put them when they are not used or how to easily access them when they are needed.

When an existing keyboard of a desktop computer is idle and not used, it is usually put horizontally on a desktop. However, this emplacement will occupy a very large space on the desktop and can increase a probability that the keyboard can be damaged. Accordingly, there are vendors who raise a rear side of the keyboard, so that the space of desktop can be saved by putting upright a widened rear wall of the keyboard when the keyboard is not used, as a keyboard height refers to a distance from a top center of a key in a home row (i.e., a center row of keys in five horizontal rows of keys of a normal keyboard), when the key is not pressed down, to the desktop. According to ISO 9241, that distance was recommended to be no greater than 35 mm and was preferably to be 30 mm; whereas, an inclination of the keyboard (i.e., an angle of inclination of the keyboard relative to the desktop) was 5° to 12°, but no greater than 15°. Therefore, if a width at a bottom of the keyboard is increased after the keyboard has been put upright in order to pursue upright stability of the keyboard, it not only will cause uncomfortableness to a user, but will invert root and branch. On the other hand, if the width at the rear side of the keyboard is not enough, the keyboard can be easily collapsed by an external force or shaking of the desk.

The design of computer keyboard should focus on allowing the user to acquire a satisfactory keying performance in a designated work and maintain comfortable satisfaction, so that the user can operate the keyboard accurately, rapidly and comfortably, before considering other functionalities. Hence, it will be beneficial to utilization for business and consumers by considering ergonomics as well as improving functionalities of products.

### SUMMARY OF THE INVENTION

The primary object of the present invention is to provide a containable computer keyboard by which a desktop space can be saved that an upright keyboard can be emplaced stably without being collapsed by a slight external force or shaking of a desk. In addition, the keyboard can be also contained in a drawer of an office desk.

Another object of the present invention is to provide a containable computer keyboard which can be designed wirelessly or with wires, wherein when the keyboard is designed with wires, a transmission wire of the keyboard can be unloaded by itself for containment.

To achieve the abovementioned objects, the computer keyboard of the present invention is provided with elastic brackets to enlarge a support surface at a bottom of the keyboard after being put upright, allowing the keyboard to be stably put upright on a desktop. Besides, through flat panels at two sides of the keyboard, the keyboard can be also contained in a drawer of an office desk.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a rear side of the present invention.

FIG. 2 shows a three-dimensional schematic view of a front side of the present invention.

FIG. 3 shows a side schematic view of the present invention which is put on a working platform with that an angle of use is raised.

FIG. 4 shows a schematic view of the present invention which is put upright.

FIG. 5 shows a three-dimensional schematic view of the present invention which is contained in a drawer.

### DETAILED DESCRIPTION OF THE PREFERRED EMBODIMENTS

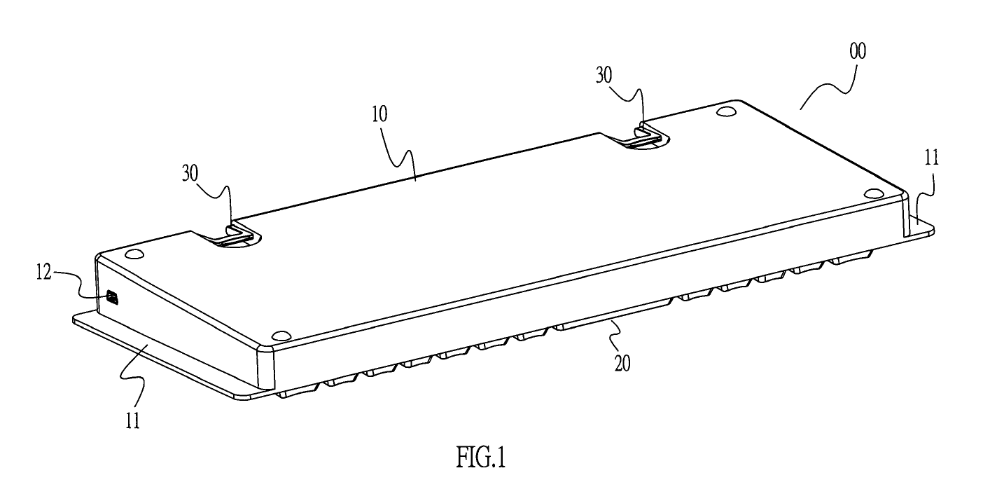

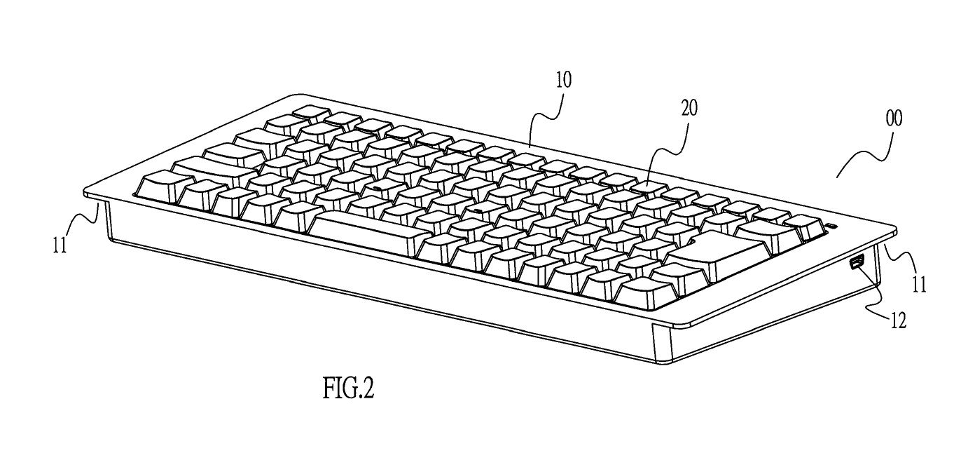

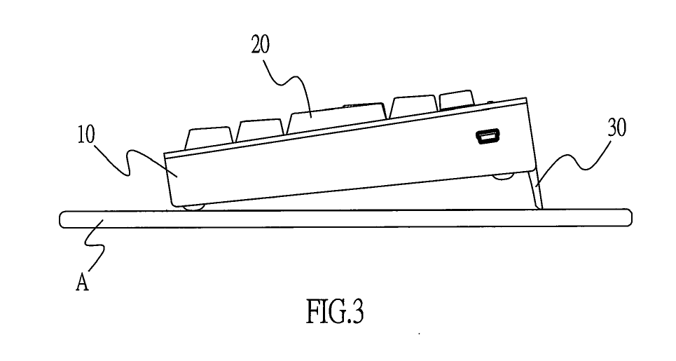

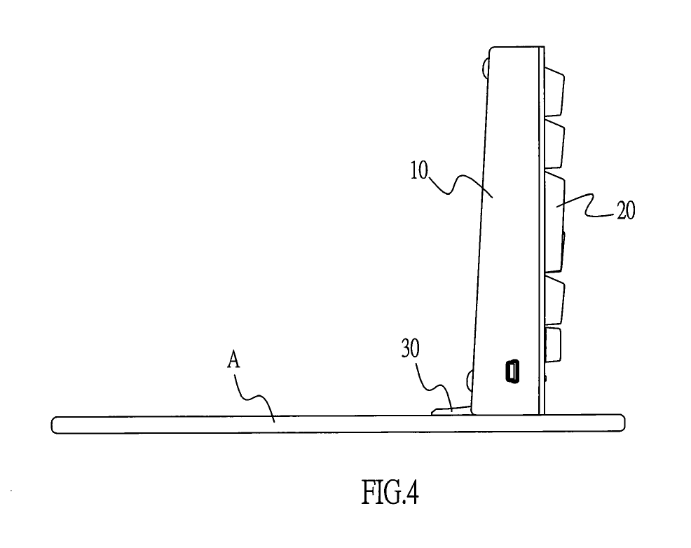

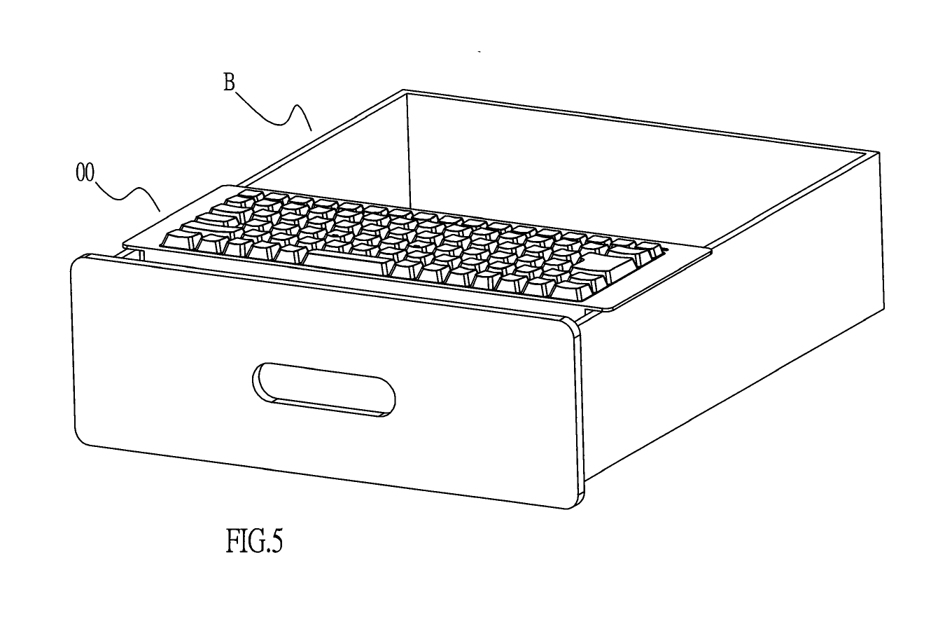

Referring to FIG. 1 and FIG. 2, it shows a three-dimensional schematic view of a rear side and a three-dimensional schematic view of a front side of a preferred embodiment of the present invention, respectively. It can be seen clearly from the drawings, along with all other drawings, that a containable computer keyboard 00 of the present invention comprises primarily a keyboard unit 10 on which is provided with plural keys 20, a rear part at a bottom cover of which is provided with plural elastic brackets 30, two sides of which are provided respectively with a flat panel 11 and a rear part at one side of which is provided with transmission equipment, i.e., a pluggable connection wire socket 12. When the computer keyboard 00 is used as a wired keyboard, a user only needs to insert a connection wire into the connection wire socket 12 for connecting and transmitting to a computer or other hardware equipment. On the other hand, when the computer keyboard 00 is not used, the user can also unload the connection wire easily to facilitate containing the keyboard 00. To allow the user to be even more convenient, the transmission equipment of the present invention can be a wireless transceiver, as well. Besides, the present invention is improved by that the provided elastic brackets 30 can rotate by pre-determined angles on the keyboard unit 10 and can also be used to raise an angle of use of the keyboard 00 (as shown in FIG. 3), so as to increase a contact area of the keyboard 00 between a working platform A when the keyboard 00 is put upright, thereby pursuing upright stability of the keyboard 00 (as shown in FIG. 4). In addition, the flat panels 11 at two sides of the keyboard unit 10 can allow the keyboard unit 10 to be contained in a drawer B of an office desk and also facilitate the user to hold by hands (as shown in FIG. 5). Compared to the prior art, the computer keyboard of the present invention is obviously more advanced.

Accordingly, the computer keyboard of the present invention not only is provided with the functionality of upright stability, but is able to be contained in the drawer B of an office desk. In addition, the present invention considers a user-friendly operational method and is comply with the ergonomic design, which can provide for utilization by businesses.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A containable computer keyboard comprising a keyboard unit, plural keys configured on the keyboard, plural elastic brackets and transmission equipment for connecting a computer, wherein the elastic brackets are used to raise an angle of use of the keyboard and increase a contact area between the keyboard and a working platform when the keyboard is upright, with that the keyboard unit is contained in a drawer of an office desk and also held by hands of a user conveniently by flat panels which are provided at two sides of the keyboard.

2. The containable computer keyboard according to claim 1, wherein the elastic brackets rotate by pre-determined angles on the keyboard unit.

3. The containable computer keyboard according to claim 1, wherein the transmission equipment is a wireless transceiver.

4. The containable computer keyboard according to claim 1, wherein the transmission equipment is a pluggable connection wire.
